(19) United States
(12) Patent Application Publication
(10) Pub. No.: US 2021/0402221 A1
(43) Pub. Date: Dec. 30, 2021

(54) DESICCANT POUCH FOR FACE COVERINGS

(71) Applicant: Pearl Auxilis Inc., Toronto (CA)

(72) Inventors: Ziting XIA, Toronto (CA); Xiaoou LI, Toronto (CA); Purushoth THAVENDRAN, Toronto (CA); Amro ASWAD, Mississauga (CA); Jing Yi WEI, Calgary (CA)

(21) Appl. No.: 17/213,433

(22) Filed: Mar. 26, 2021

Related U.S. Application Data
(60) Provisional application No. 63/044,075, filed on Jun. 25, 2020.

(51) Int. Cl. A62B 9/00; A62B 23/02

(52) U.S. Cl. CPC A62B 9/003; A62B 23/025; B32B 2307/7265; B32B 2250/05; B32B 2323/046; B32B 2369/00; B32B 2323/043; B32B 2323/10; B32B 2317/12; B32B 2377/00

(57) ABSTRACT

The present invention provides a desiccant pouch for use with a face covering. In one embodiment the desiccant pouch has a desiccant layer having a first side and a second side, a filter layer attached to the first side of the desiccant layer, and a carrier attached to the second side of the desiccant layer. In another embodiment, the desiccant pouch has a desiccant layer having a first side and a second side, a first carrier attached to the first side of the desiccant layer, and a second carrier attached to the second side of the desiccant layer.

### FIELD OF THE INVENTION

The present invention relates generally to the field of Personal Protective Equipment (PPE), and more particularly to the use of desiccants for face coverings to absorb water vapor from human breath.

### BACKGROUND OF THE INVENTION

PPE, including face coverings such as respirators and face masks, must be worn by personnel in many fields, including the healthcare, chemical, and construction industries, and other workplaces where workers may come into contact with particulate matter. In areas with significant levels of air pollution, people may also wear respirators or face masks for protection when going outdoors.

When worn, moisture from human breath often builds up between the filtering materials of a face covering, increasing breathing resistance and thereby causing user discomfort. For those who wear glasses, the humidity resulting from the buildup of moisture can also fog up the glasses, reducing visibility. When users feel uncomfortable wearing face coverings, they may discard a face covering before its working lifespan is exhausted.

Furthermore, the warm and humid dead space of face coverings constitutes an incubation bed for bacterial growth, increasing the risk of infection to users.

The problem of moisture build-up is especially critical for specific types of face coverings such as N95 respirators used by healthcare providers (HCPs) at hospitals. This type of facial respirator is ideal in areas with particulate matter as it forms a secure seal around the wearers' face and has a high-efficiency filter to prevent entry of viral particles or other pathogens during respiration.

Certain face coverings, such as N95 respirators and surgical masks, are meant to be discarded after each patient encounter or procedure that requires use of a face covering. Their structural integrity decreases over time as moisture from human breath builds up and condenses within the dead space. As a result, the filter efficiency of these face coverings is compromised.

According to 3M™, one of the major manufacturers of facial respirators and other PPE, in “3M™ Disposable Respirator 1860, 1860S, N95 Technical Data Sheet” (see https://multimedia.3m.com/mws/media/1538979O/3m-disposable-respirator-1860-1860s-technical-data-sheet.pdf), the shelf-life of a typical N95 respirator is compromised if stored in an environment with a relative humidity at or above 80%. However, human breath is at 100% RH, i.e. it is saturated with water vapor.

The outbreak of the global COVID-19 pandemic has led to critical shortages of PPE, including N95 respirators. Due to broken supply chains, HCPs must sometimes wear face coverings beyond their working lifespan, including wearing the same face covering when treating multiple patients. This increases the risk of infection to HCPs and those around them.

Patent Application WO 2017/063140 A1 discloses a dehumidifier that can be attached to the exhalation ports of certain face masks. The dehumidifier comprises a desiccant, which may be CaCl₂. In use, when the CaCl₂ absorbs moisture, it generates an alkaline liquid (CaCl₂.6H₂O) that may be collected in a lower compartment of the dehumidifier. A fill line on the liquid-containing compartment signals the end of the service life of the dehumidifier when liquid levels reach the fill line.

The shortcoming of the design in WO 2017/063140 A1 results from the use of CaCl₂. This is a deliquescent material, meaning that it turns into a liquid upon absorption of water. The design thus has a separate compartment used to contain the CaCl₂.6H₂O liquid, which adds to the overall mass of the dehumidifier. It is expected that the CaCl₂.6H₂O liquid will increase the relative humidity of the filter in a face mask to which the dehumidifier is attached, which may cause user discomfort during extended use. Further, because the dehumidifier is designed to be fitted to the exhalation port of a face mask, the dehumidifier is mask-specific and cannot be easily applied to masks with exhalation ports/valves of different shapes or dimensions. It is also not intended for use with face coverings, such as surgical masks, that do not have exhalation ports. Lastly, the dehumidifier is intended for one-time use only; once the fill line is reached, it must be discarded.

U.S. Pat. No. 5,686,161 discloses a thin, flexible adhesive strip designed to provide or adsorb moisture from containers containing goods such as food products or pharmaceuticals. For adhesive strips intended to adsorb moisture, the strip contains a desiccant such as silica gel. The thickness of the adhesive strip is minimized to be suitable for use in environments with limited space.

The strip of U.S. Pat. No. 5,686,161 is designed for use on containers. The strip is not intended to come into contact with human skin. For example, the DesiMax™ moisture absorbing label sold by Multisorb Filtration Group (see https://www.multisorb.com/), is not designed to be suitable for use in close contact with human skin or to accommodate for the properties of human breath.

Therefore, there is a need for a new desiccant pouch that can overcome the limitations of the prior art. In particular, it would be desirable for a desiccant pouch to be easily attached to and removed from different types of face coverings having different shapes and configurations (for example, with or without exhalation ports). Preferably, the desiccant pouch should be simple to manufacture, re-usable, lightweight, and come in a variety of shapes and dimensions. The desiccant pouch should be compatible with skin.

### SUMMARY OF THE INVENTION

The following presents a simplified summary of the disclosure in order to provide a basic understanding to the reader. This summary is not an extensive overview of the disclosure and it does not necessarily identify key/critical elements of the invention or delineate the scope of the invention. Its sole purpose is to present some concepts disclosed herein in a simplified form as a prelude to the more detailed description that is presented later.

The present invention provides a desiccant pouch for use with a face covering.

In one embodiment, the desiccant pouch has a desiccant layer having a first side and a second side, a filter layer attached to the first side of the desiccant layer, and a carrier attached to the second side of the desiccant layer.

The desiccant layer may contain a hygroscopic material. In some embodiments, the hygroscopic material is not deliquescent. The hygroscopic material may, for example, be silica gel, NaCl, CuSO₄, Na₂SO₄, MgSO₄, cellulose, polycarbonate, polyurethane, or a combination thereof. In embodiments where the hygroscopic material is silica gel, the silica gel may be food grade silica gel. The desiccant layer may contain about 8% to about 10% by weight orange silica gel. In certain embodiments, the desiccant layer is in the form of a desiccant paper comprising crushed silica particles in a polymeric matrix.

The filter layer may contain a high-density spun-bond polyethylene material. In some embodiments, the filter layer is coated with polyamide paint.

The carrier may contain a high-density polyethylene film, a low-density polyethylene film, nylon, polypropylene, polyester, a paper material, cloth, or a combination thereof.

The desiccant pouch may additionally have a fabric layer attached to the filter layer on the side of the filter layer facing away from the desiccant layer. The fabric layer may contain cotton, polyester, nylon, or a combination thereof.

The desiccant pouch may additionally have an adhesive layer attached to the carrier on the side of the carrier facing away from the desiccant layer. Alternatively, the desiccant pouch may additionally have an adhesive layer attached to the filter layer on the side of the filter layer facing away from the desiccant layer. The adhesive layer may be a double-sided adhesive, a pressure-sensitive adhesive, another tacky material, or a combination thereof.

In another embodiment, the desiccant pouch has a desiccant layer having a first side and a second side, a first carrier attached to the first side of the desiccant layer, and a second carrier attached to the second side of the desiccant layer.

The desiccant layer may contain a hygroscopic material. In some embodiments, the hygroscopic material is not deliquescent. The hygroscopic material may, for example, be silica gel, NaCl, CuSO₄, Na₂SO₄, MgSO₄, cellulose, polycarbonate, polyurethane, or a combination thereof. In embodiments where the hygroscopic material is silica gel, the silica gel may be food grade silica gel. The desiccant layer may contain about 8% to about 10% by weight orange silica gel. In certain embodiments, the desiccant layer is in the form of a desiccant paper comprising crushed silica particles in a polymeric matrix.

The first carrier and the second carrier may independently contain a high-density polyethylene film, a low-density polyethylene film, nylon, polypropylene, polyester, a paper material, cloth, or a combination thereof.

The desiccant pouch may additionally have an adhesive layer attached to the first carrier on the side of the first carrier facing away from the desiccant layer. The adhesive layer may be a double-sided adhesive, a pressure-sensitive adhesive, another tacky material, or a combination thereof.

### BRIEF DESCRIPTION OF THE DRAWINGS

For a more complete understanding of the present disclosure, the invention is illustrated in the figures of the accompanying drawings, which are meant to be exemplary and not limiting, and in which like reference numbers indicate like features.

FIG. 1 is a cross-sectional view of a portion of a desiccant pouch in accordance with an embodiment of the present invention.

FIG. 2a is a front view of a face covering.

FIG. 2b is rear view of the face covering of FIG. 2a, showing the desiccant pouch of FIG. 1 attached to the face covering.

FIG. 3 is an exploded view of the desiccant pouch of FIG. 1, showing the water vapor transport pathway through the different layers of the desiccant pouch.

FIG. 4 is an exploded view of a desiccant pouch in accordance with an alternate embodiment of the present invention, showing the water vapor transport pathway through the different layers of the desiccant pouch.

FIG. 5 is an exploded view of an experimental setup for testing absorption of water vapor by a sorbent, hygroscopic material.

FIG. 6 is a graph showing data obtained from a preliminary experiment used to determine the saturation time for silica gel beads exposed to water vapour.

### DETAILED DESCRIPTION

Disclosed herein is a desiccant pouch for use with a face covering. The desiccant pouch is suitable for use with both medical and non-medical grade face coverings. The face covering may be disposable, such as an N95 respirator or surgical mask, or may be re-usable, such as a face shield, a cloth face mask, or any medical or non-medical grade face mask used by the general public (such as respirators with activated carbon filters which may be used by street artists during painting). The desiccant pouch may be provided in a variety of shapes and configurations (for example, in the form of a thin strip), and may be used with face coverings of different shapes, dimensions, and curvatures. In use, the desiccant pouch tends to reduce moisture build-up from human breath, thereby increasing user comfort and preserving the structural integrity and filter efficiency to prolong the lifespan of such face coverings.

A cross-sectional view of a portion of a desiccant pouch 1, provided in accordance with an embodiment of the present invention, is shown in FIG. 1. Desiccant pouch 1 includes desiccant layer 3 comprising a sorbent, hygroscopic material that is permeable to air and absorbs moisture from air passing through it. Preferably, the hygroscopic material is not deliquescent. The hygroscopic material may be regenerable, for example, by heating, to allow for re-use of desiccant pouch 1. Alternatively, desiccant pouch 1 may be intended to be disposable to reduce the risk of cross-contamination.

The hygroscopic material may, for example, be silica gel (preferably food grade silica gel), the edible non-toxic desiccant disclosed in CN105413416A (which comprises, by percent weight, 10-20% bran, 40-65% anhydrous calcium chloride, 2-5% talcum powder, 5-20% konjac flour, and 15-30% sodium chloride), NaCl, CuSO₄, Na₂SO₄, MgSO₄, cellulose, polycarbonate, polyurethane, or a combination thereof. In certain embodiments, desiccant layer 3 may be in the form of a desiccant paper comprising crushed silica particles in a polymeric matrix (such as a cellulose fibre matrix, or polycarbonate with a pore size on the micron scale) that tends to prevent escape of the finer silica particles. Preferably, the amount of hygroscopic material provided is chosen so that the hygroscopic material itself, as well as the water vapor absorbed by it, do not add too much extra weight to the face covering to which desiccant pouch 1 is applied. For example, where desiccant layer 3 comprises silica gel, the amount of silica gel provided may be up to about 10 g or about 12.5 g.

A first side of desiccant layer 3 is attached to filter layer 5. This may be done, for example, by heat lamination, sewing or a combination thereof. Filter layer 5 tends to prevent fine particles from desiccant layer 3 from escaping desiccant pouch 1 and entering the user's respiratory tract. Filter layer 5 is intended to be located on the side of desiccant layer 3 facing the user when desiccant pouch 1 is attached to a face covering. Filter layer 5 is made of a material that is water-permeable. Filter layer 5 can, for example, comprise Tyvek™, a high-density, spun-bond polyethylene material available from DuPont™. Filter layer 5 can comprise a water-permeable nanocomposite thin-film membrane having nanoparticles made of multi-walled carbon nanotubes with a thickness of less than 150 nm, similar to that described in J. A. Idarraga-Mora, A. S. Childress, P. S. Friedel, D. A. Ladner, A. Rao, and S. Husson, “Role of Nanocomposite Support Stiffness on TFC Membrane Water Permeance,” Membranes, vol. 8, no. 4, p. 111, November 2018. Filter layer 5 may be coated with polyamide paint to contain any silica dust.

The second side of desiccant layer 3 is attached to carrier 7 to prevent the desiccant layer 3 from directly contacting adhesive layer 11 (when present), which is described further below. Direct contact of desiccant layer 3 with adhesive layer 11 may damage the hygroscopic material and reduce its ability to absorb moisture effectively. The layers may be attached, for example, by heat lamination, sewing or a combination thereof. Carrier 7 is intended to be located on the side of desiccant layer 3 facing away from the user when desiccant pouch 1 is attached to a face covering. Carrier 7 may, for example, comprise a high- or low-density polyethylene film, nylon, polypropylene, polyester, a paper material, cloth, or a combination thereof.

The side of filter layer 5 facing away from desiccant layer 3 (i.e. the side facing the user when desiccant pouch 1 is attached to a face covering) may have fabric layer 9 attached to it. This may be done by sewing or adhesion. Fabric layer 9 comprises a wicking material and is intended to promote user comfort. Fabric layer 9 may, for example, comprise cotton, polyester, nylon, or a combination thereof. Preferably cotton is used for fabric layer 9.

The side of carrier 7 facing away from desiccant layer 3 (i.e. the side facing away from the user when desiccant pouch 1 is attached to a face covering) may have adhesive layer 11 attached to it. The adhesive in adhesive layer 11 is preferably breathable, and may be selected so that desiccant pouch 1 may be quickly and easily attached to and removed from a face covering. In certain embodiments, the adhesive does not leave any residue on the face covering after removal of desiccant pouch 1. Additionally, the adhesive preferably does not damage the face covering that desiccant pouch 1 is applied to. The adhesive may be heat-resistant. Adhesive layer 11 may, for example, comprise a double-sided adhesive, a pressure-sensitive adhesive, another tacky material, or a combination thereof. For example, a polyester carrier having adhesive on both sides, such as the removable and repositionable 9415PC™ tape manufactured by 3M™, may be used. Alternatively, a tape such as the Kapton™ polyimide film-based tape manufactured by DuPont™ may be used. Adhesive layer 11 may be attached to carrier 7 by, for example, lamination, sewing, or through the use of pressure (where adhesive layer 11 comprises a double-sided adhesive or other tacky material). In embodiments of desiccant pouch 1 without an adhesive layer, desiccant pouch 1 may be sewn to the inside of a face covering, or slipped into a pocket on the inside of the face covering.

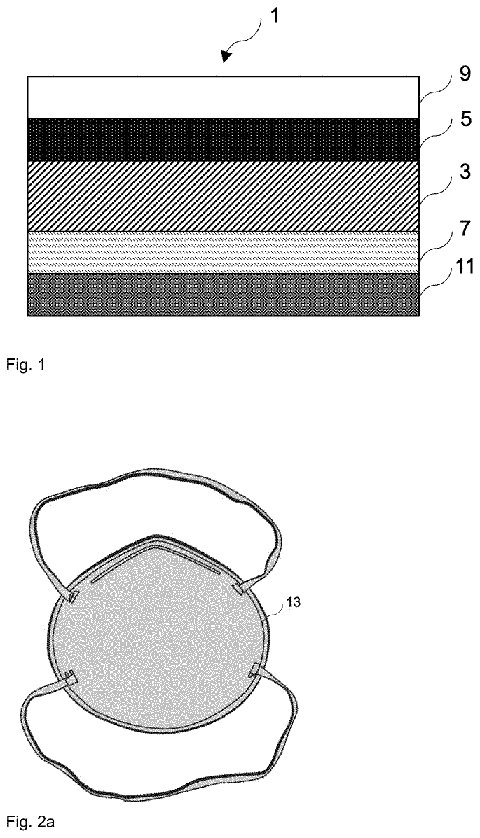

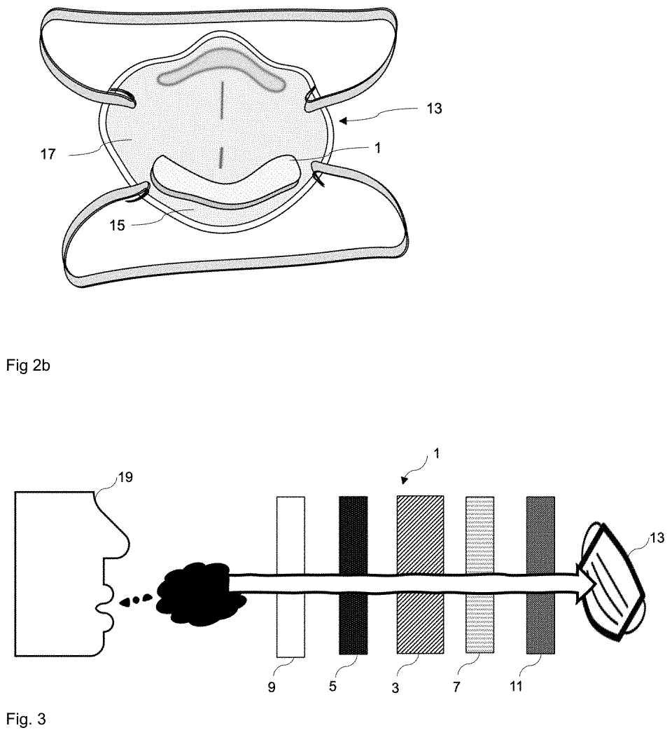

In use, adhesive layer 11 attaches desiccant pouch 1 to face covering 13. Fabric layer 9, when present, is oriented such that it faces the user. Referring to FIG. 2a, the exterior of face covering 13 preferably does not undergo any change when desiccant pouch 1 is attached to it. Desiccant pouch 1 may be fitted in dead space 15 in the interior 17 of face covering 13, as shown in FIG. 2b. Attachment of desiccant pouch 1 preferably does not interfere with the fit of face covering 13 on the user's face. Desiccant pouch 1 may be attached along the perimeter of dead space 15 to avoid directly blocking the flow of breath. Preferably, attachment of desiccant pouch 1 does not change the original dimensions of face covering 13, and the added extrusion is minimal.

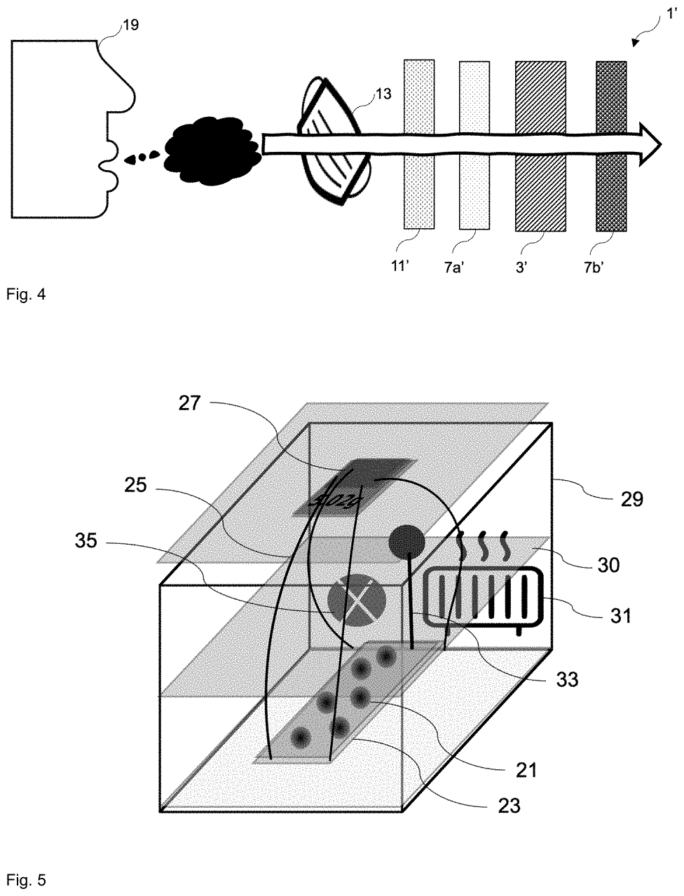

FIG. 3 shows an exploded view of desiccant pouch 1 of FIG. 1. In use, desiccant pouch 1 is placed on the inside of face covering 13. As shown by the arrow, water vapor found in exhaled air from user 19 will first come in contact with fabric layer 9 (when present), and will then travel via diffusion through filter layer 5 to be absorbed by desiccant layer 3. The movement of water vapor is expected to be governed by Fick's Law of Diffusion until it reaches desiccant layer 3, where absorption will be the dominant process. After the absorption process, any remaining water vapor will travel through carrier 7 and adhesive layer 11 (when present), at which point it will contact the face covering. The user can use any number of desiccant pouches required to effectively reduce moisture build-up in his or her face covering.

In an alternative embodiment, the desiccant pouch may be designed to be placed on the outside of the face covering 13. In such an embodiment, as shown in FIG. 4, desiccant pouch 1′ comprises desiccant layer 3′ (which may comprise any of the materials described above in desiccant layer 3). A first side of desiccant layer 3′ is attached to either carrier 7a′ (which may comprise any of the materials described above in carrier 7) or filter layer 5′ (which may comprise any of the materials described above in filter layer 5). The second side of desiccant layer 3′ is attached to carrier 7b′ (which may comprise any of the materials described above in carrier 7). Carrier 7a′ and carrier 7b′ may or may not comprise the same materials. The side of carrier 7a′ or filter layer 5′ facing away from desiccant layer 3′ (i.e. the side facing the user when desiccant pouch 1′ is attached to the outside of a face covering) may have attached to it adhesive layer 11′ (which may comprise any of the materials described above in adhesive layer 11). When present, adhesive layer 11′ may be used to attach desiccant pouch 1′ to the exterior of face covering 13. In embodiments of desiccant pouch 1′ without an adhesive layer, desiccant pouch 1′ may be sewn to the outside of a face covering, or slipped into a pocket on the outside of the face covering. The materials used for carrier 7a′, filter layer 5′ and carrier 7b′ are selected to be both air and water permeable. In some embodiments, carrier 7a′ can itself comprise an adhesive material for attaching desiccant pouch 1′ to a face covering.

In certain embodiments, an indicator may be provided to signal the end of the useful life of desiccant pouch 1 or 1′. For example, when desiccant layer 3 or 3′ comprises silica gel, the silica gel may comprise orange silica gel (which has methyl violet) in addition to white silica gel. In certain embodiments, desiccant layer 3 or 3′ is approximately 8-10% by weight orange silica gel, with the balance being white silica gel. Preferably, the orange silica gel is present at about 10% by weight. Upon saturation with water, the orange silica gel will turn dark green in colour. This colour change indicates the end of the useful life of desiccant pouch 1 or 1′. Where a colour indicator, such as that described above, is used, the layers of desiccant pouch 1 or 1′ are chosen so that the colour change is visible through those layers.

As will be appreciated, given the specific surface area and volume of a particular hygroscopic material provided in desiccant layer 3 or 3′, one can roughly calculate the expected hours of useful life for a desiccant pouch. This calculation would be based on the assumption that a user will wear a face covering with the desiccant pouch continuously, as has happened for many HCPs during a shift in the course of the COVID-19 pandemic. This expected working useful life may, in certain embodiments, be provided on a label on the packaging of the desiccant pouch or on the desiccant pouch itself. Therefore, even if a user does not take off his or her face covering to conduct a visual inspection to identify a color change in the desiccant pouch (in embodiments where colour is used as an indicator), the user will still have a rough idea of how long the desiccant pouch may be used for. For example, a desiccant pouch having approximately 12.5 g of silica gel may be used for a period of about 4 hours.

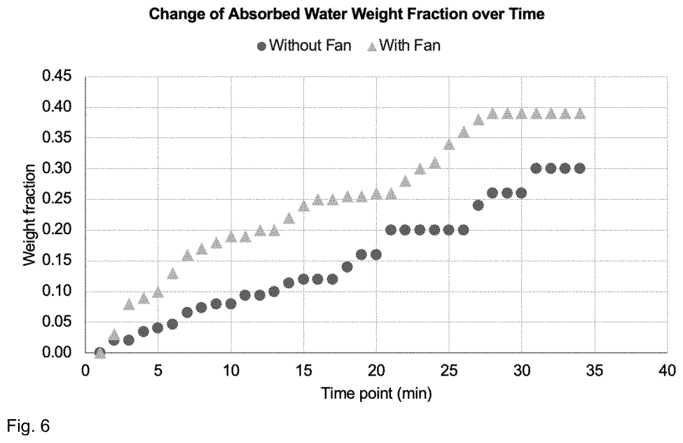

A preliminary experiment was conducted to determine the mass transfer rate when water vapor passes through silica gel beads. As shown in FIG. 5, 5 g of “Dry-and-Dry”™ premium orange indicating silica gel desiccant beads 21 (see https://dryndry.com/collections/silica-gel-beads/products/1-quart2-lbs-dry-dry-premium-orange-indicating-silica-gel-desicant-bead) was placed in aluminum pan 23. Pan 23 with silica gel beads 21 was then suspended by wire 25 from scale 27 and into sealed container 29. Secondary lid 30 was placed above pan 23 and within container 29 to prevent condensed water from falling on silica gel beads 21. Container 29 had the following dimensions: 8.3″ (W), 12.2″ (L), 12.3″ (H) with 3.5 Gallon capacity. To keep the relative humidity in container 29 at 100%, approximately 5 L of water was placed in container 29. The temperature in container 29 was maintained at about 37-40° C. by use of heater 31. Thermometer 33 was inserted through a hole in the top cover of container 29 and placed above secondary lid 30. A small fan 35 was attached to the wall of container 29 to imitate the movement of air during exhalation. The weight of pan 23 with silica gel beads 21 was recorded at regular intervals. As shown in FIG. 6, it took about 3.5-4.5 hours for 5 g of silica gel beads to reach equilibrium saturation, which is at 40% weight fraction. The time taken to reach saturation is indicative of the useful lifespan of a scaled-up desiccant pouch in a 100% RH environment.

The abbreviation mm as used herein refers to millimetres (or in the US, “millimeters”). The abbreviation cm as used herein refers to centimeters (or in the US, “centimeters”).

Where, in this document, a list of one or more items is prefaced by the expression “such as” or “including”, is followed by the abbreviation “etc.”, or is prefaced or followed by the expression “for example”, or “e.g.”, this is done to expressly convey and emphasize that the list is not exhaustive, irrespective of the length of the list. The absence of such an expression, or another similar expression, is in no way intended to imply that a list is exhaustive. Unless otherwise expressly stated or clearly implied, such lists shall be read to include all comparable or equivalent variations of the listed item(s), and alternatives to the item(s), in the list that a skilled person would understand would be suitable for the purpose that the one or more items are listed. Unless expressly stated or otherwise clearly implied herein, the conjunction “or” as used in the specification and claims shall be interpreted as a non-exclusive “or” so that “X or Y” is true when X is true, when Y is true, and when both X and Y are true, and “X or Y” is false only when both X and Y are false.

The words “comprises” and “comprising”, when used in this specification and the claims, are used to specify the presence of stated features, elements, integers, steps or components, and do not preclude, nor imply the necessity for, the presence or addition of one or more other features, elements, integers, steps, components or groups thereof.

It should be understood that the above-described embodiments of the present invention, particularly, any “preferred” embodiments, are only examples of implementations, merely set forth for a clear understanding of the principles of the invention. Many variations and modifications may be made to the above-described embodiment(s) of the invention as will be evident to those skilled in the art. That is, persons skilled in the art will appreciate and understand that such modifications and variations are, or will be, possible to utilize and carry out the teachings of the invention described herein.

The scope of the claims that follow is not limited by the embodiments set forth in the description. The claims should be given the broadest purposive construction consistent with the description and figures as a whole.

1. A desiccant pouch for use with a face covering, the desiccant pouch comprising:
a desiccant layer having a first side and a second side;
a filter layer attached to the first side of the desiccant layer; and
a carrier attached to the second side of the desiccant layer.

2. The desiccant pouch of claim 1, wherein the desiccant layer comprises a hygroscopic material.

3. The desiccant pouch of claim 2, wherein the hygroscopic material is not deliquescent.

4. The desiccant pouch of claim 2, wherein the hygroscopic material is silica gel, NaCl, CuSO₄, Na₂SO₄, MgSO₄, cellulose, polycarbonate, polyurethane, or a combination thereof.

5. The desiccant pouch of claim 4, wherein the hygroscopic material is silica gel.

6. The desiccant pouch of claim 5, wherein the desiccant layer comprises about 8% to about 10% by weight orange silica gel.

7. The desiccant pouch of claim 5, wherein the desiccant layer is in the form of a desiccant paper comprising crushed silica particles in a polymeric matrix.

8. The desiccant pouch of claim 1, wherein the filter layer comprises a high-density spun-bond polyethylene material.

9. The desiccant pouch of claim 1, wherein the filter layer is coated with polyamide paint.

10. The desiccant pouch of claim 1, wherein the carrier comprises a high-density polyethylene film, a low-density polyethylene film, nylon, polypropylene, polyester, a paper material, cloth, or a combination thereof.

11. The desiccant pouch of claim 1, further comprising a fabric layer attached to the filter layer on the side of the filter layer facing away from the desiccant layer.

12. The desiccant pouch of claim 11, wherein the fabric layer comprises cotton, polyester, nylon, or a combination thereof.

13. The desiccant pouch of claim 1, further comprising an adhesive layer attached to the carrier on the side of the carrier facing away from the desiccant layer.

14. The desiccant pouch of claim 1, further comprising an adhesive layer attached to the filter layer on the side of the filter layer facing away from the desiccant layer.

15. A desiccant pouch for use with a face covering, the desiccant pouch comprising:
a desiccant layer having a first side and a second side;
a first carrier attached to the first side of the desiccant layer; and
a second carrier attached to the second side of the desiccant layer.

16. The desiccant pouch of claim 15, wherein the desiccant layer comprises a hygroscopic material.

17. The desiccant pouch of claim 16, wherein the hygroscopic material is not deliquescent.

18. The desiccant pouch of claim 16, wherein the hygroscopic material is silica gel, NaCl, CuSO₄, Na₂SO₄, MgSO₄, cellulose, polycarbonate, polyurethane, or a combination thereof.

19. The desiccant pouch of claim 15, wherein the first carrier and the second carrier independently comprise a high-density polyethylene film, a low-density polyethylene film, nylon, polypropylene, polyester, a paper material, cloth, or a combination thereof.

20. The desiccant pouch of claim 15, further comprising an adhesive layer attached to the first carrier on the side of the first carrier facing away from the desiccant layer.
